(19) United States
(12) Patent Application Publication
(10) Pub. No.: US 2023/0315959 A1
(43) Pub. Date: Oct. 5, 2023

(54) DESIGN SUPPORT APPARATUS, DESIGN SUPPORT PROGRAM, AND DESIGN SUPPORT METHOD

(71) Applicants: MITSUBISHI HEAVY INDUSTRIES, LTD., Tokyo (JP); FLOSFIA INC., Kyoto (JP)

(72) Inventors: Masato ITO, Tokyo (JP); Masaya MITAKE, Tokyo (JP); Kengo TAKEUCHI, Kyoto (JP); Toshimi HITORA, Kyoto (JP); Fujio OKUI, Kyoto (JP)

(21) Appl. No.: 18/089,883

(22) Filed: Dec. 28, 2022

Related U.S. Application Data
(63) Continuation-in-part of application No. PCT/JP2022/029867, filed on Aug. 3, 2022.

(30) Foreign Application Priority Data
Aug. 4, 2021 (JP) 2021-128634

(51) Int. Cl. G06F 30/3308

(52) U.S. Cl. CPC G06F 30/3308; G06F 2119/08

(57) ABSTRACT

Provided a design support apparatus of supporting design of a component embedded substrate including one or more embedded electronic components that configure at least a part of a circuit, including, a component information acquiring unit that acquires component information about the electronic components to be incorporated in the component embedded substrate; and a required minimum area calculating unit that calculates a required minimum area of a surface of the component embedded substrate on the basis of at least information about a size of each electronic component contained in the component information.

### CROSS REFERENCE TO RELATED APPLICATION

This application is a continuation-in-part application of International Pat. Application No. PCT/JP2022/029867 (Filed on Aug. 3, 2022), which claims the benefit of priority from Japanese Pat. Application No. 2021-128634 (filed on Aug. 4, 2021).

The entire contents of the above applications, which the present application is based on, are incorporated herein by reference.

### 1. FIELD OF THE INVENTION

The disclosure relates to a design support apparatus, a design support program, and a design support method intended to support designs of a circuit and a module or design of the circuit or the module.

### 2. DESCRIPTION OF THE RELATED ART

In mounting a semiconductor module on a mounting board, etc., increase in functions of a chip involves complication of design of wiring for connection on a wiring board with a mounted semiconductor chip between the semiconductor chip and an electric component such as another semiconductor chip, a resistor, or a capacitor, for example. In recent years, mounting design using a multi-chip module (MCM) or a chip size package (CSP) has been made actively, for example. Such mounting design is made using a design technique of mounting a component on a high-density substrate (hereinafter also called a “subordinate substrate”) and mounting the subordinate substrate on a master substrate while treating the subordinate substrate with the mounted component in its entirety as one component.

As an example, a known substrate designing apparatus includes: a data acquiring unit that acquires data about a component outer shape indicating the shape and size of a component and about terminal information indicating the position of a terminal belonging to the component; a component rectangle calculating unit that calculates a component rectangle corresponding to the shape and size of a target component using component data about each target component; and an occupancy rectangle calculating unit that calculates an occupancy rectangle having a size of a range to be ensured in a substrate for the target component by adding an additive region around the component rectangle of each target component.

On the other hand, from the viewpoint of reducing the size and thickness of a circuit board module used for electronic equipment, an electronic component embedded substrate with an internally embedded electronic component such as a power semiconductor element has been suggested. At the electronic component embedded substrate, the internally embedded electronic component and wiring formed on a surface of the electronic component embedded substrate are connected to each other through a via conductor formed at the substrate, for example. As an example, a known electronic component embedded substrate includes an embedded power semiconductor element, an embedded control element, and an embedded coil.

### SUMMARY OF THE INVENTION

According to an example of the present disclosure, there is provided a design support apparatus of supporting design of a component embedded substrate including one or more embedded electronic components that configure at least a part of a circuit, including, a component information acquiring unit that acquires component information about the electronic components to be incorporated in the component embedded substrate; and a required minimum area calculating unit that calculates a required minimum area of a surface of the component embedded substrate on the basis of at least information about a size of each electronic component contained in the component information.

According to an example of the present disclosure, there is provided a computer-readable non-transitory recording medium storing a program that causes a computer to execute a procedure, the procedure that supports design of a component embedded substrate including one or more embedded electric components configuring at least a part of a circuit, the procedure including, acquiring component information about the electronic components to be incorporated in the component embedded substrate; and calculating a required minimum area of a surface of the component embedded substrate on the basis of at least information about a size of each electronic component contained in the component information.

According to an example of the present disclosure, there is provided a design support method of supporting design of a component embedded substrate including one or more embedded electronic components that configure at least a part of a circuit, including at least, acquiring component information about the electronic components to be incorporated in the component embedded substrate; and calculating a required minimum area of a surface of the component embedded substrate on the basis of at least information about a size of each electronic component contained in the component information.

Thus, a design support apparatus, a computer-readable non-transitory recording medium storing a program, and a design support method of the present disclosure allow the design to be made efficiently by giving consideration to an element peculiar to the component embedded substrate in making design including derivation of a required minimum area of a component embedded substrate.

### BRIEF DESCRIPTION OF THE DRAWINGS

FIG. 1 is a block diagram illustrating the configuration of a design support apparatus according to a first embodiment.

FIG. 2 is a flowchart illustrating a processing procedure of a design support method according to the first embodiment.

FIG. 3 is a view schematically illustrating one configuration of a circuit diagram according to an embodiment of the disclosure.

FIG. 4A is a schematic view describing a circuit database.

FIG. 4B is a schematic view describing a component database.

FIG. 5 is a flowchart illustrating a processing procedure of the design support method according to the first embodiment.

FIG. 6 is a flowchart specifically describing a processing procedure of calculating a required minimum pad area according to the first embodiment.

FIG. 7 is a flowchart illustrating a processing procedure of a design support method according to a second embodiment.

FIG. 8 is a view schematically illustrating a simplified model applied during calculation of a junction-to-case thermal resistance according to the second embodiment.

FIG. 9 is a block diagram illustrating the configuration of a design support apparatus according to a third embodiment.

FIG. 10 is a flowchart illustrating a processing procedure of a design support method according to the third embodiment.

FIG. 11 is a top view schematically illustrating layout of electrode pads on a surface of a component embedded substrate.

FIG. 12 is a schematic view for describing a required minimum mounting area of a component embedded substrate.

### DETAILED DESCRIPTION

The present inventors have found a problem that, in the technical field of an electronic component embedded substrate (in particular, the substrate with an embedded power semiconductor element), in determining a required area of a surface of the electronic component embedded substrate responsive to a size of each electronic component to be mounted internally, it is necessary to give consideration not only to setting of an additive region based on terminal information, etc. but also to influence by a through hole, thermal influence, etc. Specifically, it is requested to provide a design support apparatus that makes it possible to give consideration to an element peculiar to a component embedded substrate in determining a required minimum area of the component embedded substrate.

As a result of earnest examination made to fulfill the above-described intention, the present inventors have found that the above-described problem is solvable by a design support apparatus of support design of a component embedded substrate including one or more embedded electronic components that configure at least a part of a circuit, including: a component information acquiring unit that acquires component information about the electronic components to be incorporated in the component embedded substrate; and a required minimum area calculating unit that calculates a required minimum area of a surface of the component embedded substrate on the basis of at least information about a size of each electronic component contained in the component information.

Embodiments of the present disclosure will be described below with reference to the accompanying drawings. In the following description, the same parts and components are designated by the same reference numerals. The present embodiment includes, for example, the following disclosures.

### Structure 1

A design support apparatus of supporting design of a component embedded substrate including one or more embedded electronic components that configure at least a part of a circuit, including: a component information acquiring unit that acquires component information about the electronic components to be incorporated in the component embedded substrate; and a required minimum area calculating unit that calculates a required minimum area of a surface of the component embedded substrate on the basis of at least information about a size of each electronic component contained in the component information.

### Structure 2

The design support apparatus according to [Structure 1], further including: a circuit component information acquiring unit that acquires information about circuit components to be included in the circuit from a circuit database containing information about a configuration of the circuit; and an incorporated component selecting unit that selects a component to be incorporated in the component embedded substrate from the circuit components, the component information acquiring unit acquiring information about one or more electronic components selected by the incorporated component selecting unit.

### Structure 3

The design support apparatus according to [Structure 1] or [Structure 2], wherein the required minimum area of the component embedded substrate is calculated by using a required minimum mounting area that is derived on the basis of a component area obtained as a total of each area of the electronic components to be incorporated in the component embedded substrate.

### Structure 4

The design support apparatus according to any one of [Structure 1] to [Structure 3], wherein the required minimum area is calculated by using a required minimum pad area that is derived on the basis of each area of one or more electrode pads to be mounted on the surface of the component embedded substrate.

### Structure 5

The design support apparatus according to [Structure 4], wherein the required minimum pad area is derived on the basis of geometry information containing at least information about a layer structure, a copper foil thickness, and a substrate material of a mounting board on which the component embedded substrate is to be mounted.

### Structure 6

The design support apparatus according to any one of [Structure 1] to [Structure 5], wherein at least one of the electronic components is a power device.

### Structure 7

The design support apparatus according to any one of [Structure 1] to [Structure 6], wherein the required minimum area of the component embedded substrate is calculated by further using a required heat dissipation area of the component embedded substrate.

### Structure 8

The design support apparatus according to any one of [Structure 1] to [Structure 7], further including: a thermal simulation unit that conducts a thermal simulation on the component embedded substrate by using information about the required minimum area.

### Structure 9

A computer-readable non-transitory recording medium storing a program that causes a computer to execute a procedure, the procedure that supports design of a component embedded substrate including one or more embedded electric components configuring at least a part of a circuit, the procedure including: acquiring component information about the electronic components to be incorporated in the component embedded substrate; and calculating a required minimum area of a surface of the component embedded substrate on the basis of at least information about a size of each electronic component contained in the component information.

### Structure 10

A design support method of supporting design of a component embedded substrate including one or more embedded electronic components that configure at least a part of a circuit, including at least: acquiring component information about the electronic components to be incorporated in the component embedded substrate; and calculating a required minimum area of a surface of the component embedded substrate on the basis of at least information about a size of each electronic component contained in the component information.

A design support apparatus supports design of a component embedded substrate including one or more embedded electronic components that configure at least a part of a circuit, and is characterized in that the design support apparatus includes: a component information acquiring unit that acquires component information about the electronic component to be incorporated in the component embedded substrate; and a required minimum area calculating unit that calculates a required minimum area of a surface of the component embedded substrate on the basis of at least information about a size of each electronic component contained in the component information.

While embodiments of the design support apparatus of the disclosure will be described below using the drawings, the disclosure is not limited to these embodiments.

### (First Embodiment)

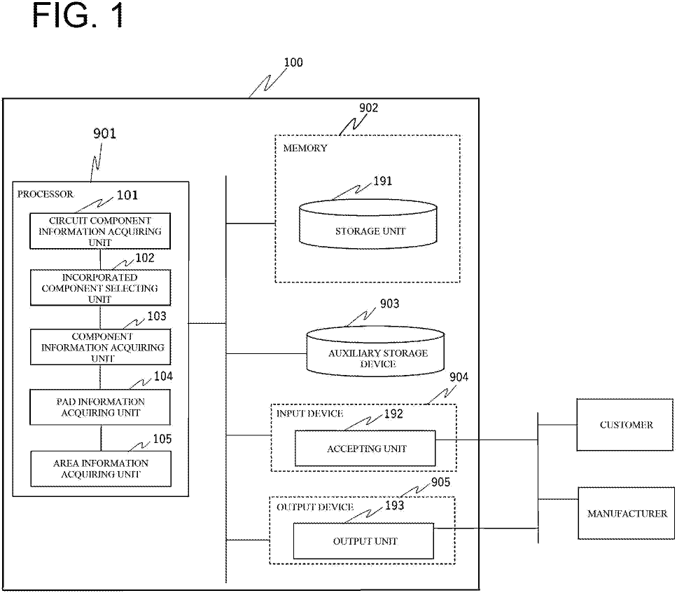

A design support apparatus 100 in FIG. 1 is a computer with hardware including a processor 901, a memory 902, an auxiliary storage device 903, an input device 904, and an output device 905. The processor 901 is connected to the other hardware through a signal line.

The processor 901 is an IC (integrated circuit) that performs processing and controls the other hardware. More specifically, the processor 901 is a CPU (central processing unit), a DSP (digital signal processor), or a GPU (graphics processing unit). The memory 902 is a volatile storage device. The memory 902 is also called a main storage device or a main memory. More specifically, the memory 902 is a RAM (random access memory).

The auxiliary storage device 903 is a nonvolatile storage device. More specifically, the auxiliary storage device 903 is a ROM (read only memory) or an HDD (hard disc drive). The input device 904 is a device to accept an input. More specifically, the input device 904 is a keyboard, a mouse, a numeric keypad, or a touch panel, for example. In an embodiment of the disclosure, the input device 904 may be a device connected through a network to an external customer’s terminal, for example, and may accept information input by an external designer (customer) using an accepting unit 192. The information input to the input device 904 may be supplied as digital information through a network, for example. As a more specific example, the information input to the input device 904 may be information (digital information) input from the customer’s terminal and supplied through the network.

The output device 905 is a device to produce an output. More specifically, the output device 905 is a monitor to make a display or a printer to produce a print, for example. In an embodiment of the disclosure, the output device may be a device connected through a network to an external customer’s terminal, for example, and may be configured in such a manner as to allow display of output information through an output unit 193 on a display of a terminal belonging to an external designer (customer), for example. The information output by the output device 905 may be supplied as digital information through a network, for example. As a more specific example, the information output by the output device 905 may be displayed through a network on a customer’s terminal or on a display of a manufacturer, for example.

The design support apparatus 100 includes “units” provided as elements forming a functional configuration including a circuit component information acquiring unit 101, an incorporated component selecting unit 102, a component information acquiring unit 103, a pad information acquiring unit 104, and an area information acquiring unit 105. The functions of the “units” are realized using software. The functions of the “units” will be described later.

The auxiliary storage device 903 stores a program for realizing the functions of the “units.” The program for realizing the functions of the “units” is loaded on the memory 902 and executed by the processor 901. The auxiliary storage device 903 further stores an OS (operating system). At least part of the OS is loaded on the memory 902 and run by the processor 901. Specifically, the processor 901 executes the program for realizing the functions of the “units” while running the OS. The program may be recorded (stored) on a computer-readable non-transitory recording medium.

Data obtained by executing the program for realizing the functions of the “units” is stored into a storage device that may be the memory 902, the auxiliary storage device 903, a register in the processor 901, or a cache memory in the processor 901. The design support apparatus 100 may include a plurality of processors 901 and these processors 901 may work together to execute the program for realizing the functions of the “units.”

The memory 902 functions as a storage unit 191 storing data. However, a storage device other than the memory 902 may function as the storage unit 191. The input device 904 functions as the accepting unit 192 that accepts an input. The output device 905 functions as the output unit 193 that produces an output.

The “units” may be read as “processes” or as “steps.” The functions of the “units” may be realized using firmware. The program for realizing the functions of the “units” may be stored into a nonvolatile storage medium such as a magnetic disk, an optical disk, or a flash memory.

The operation of the design support apparatus 100 corresponds to a design support method. A procedure of the design support method corresponds to a procedure of a design support program.

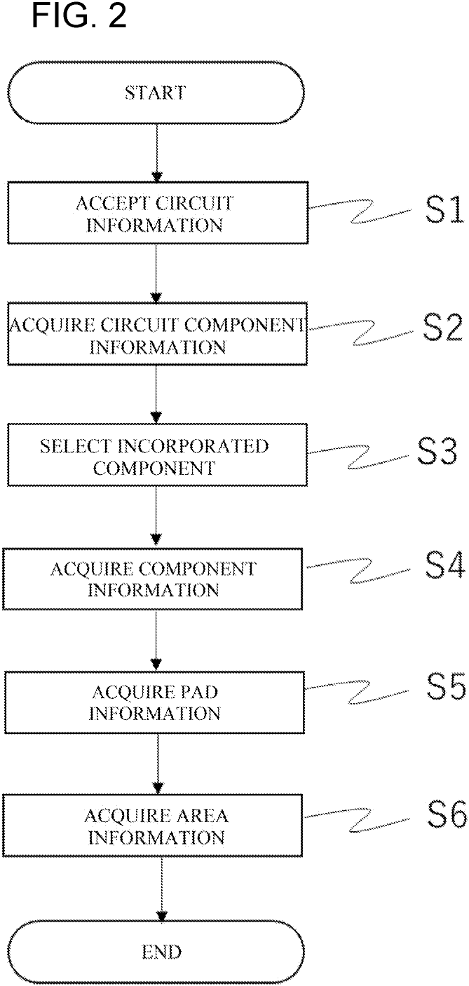

The operation of the design support apparatus 100 (design support method) will be described on the basis of FIG. 2.

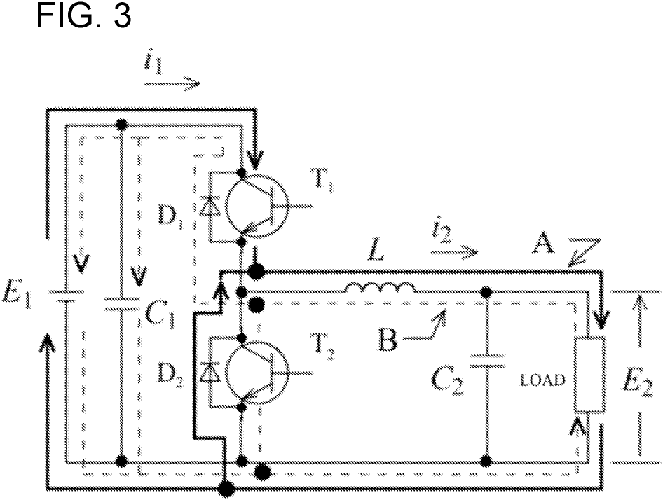

In step S1, a designer operates the input device 904 to input circuit information, and the accepting unit 192 accepts the input circuit information. In an embodiment of the disclosure, the designer (customer) may operate an external terminal to input the circuit information, and the input device 904 may acquire (accept) the input circuit information through the accepting unit 192. Specifically, the circuit information is a circuit type name and a circuit diagram, for example. Examples of the circuit type name include a half-bridge circuit, a full-bridge circuit, a boost chopper circuit, and a step-down chopper circuit. The circuit type name is not limited to these examples as long as it indicates a basic circuit configuration including at least an electronic component to be incorporated in a component embedded substrate. While the circuit diagram may be a circuit diagram illustrated in FIG. 3, for example, it is not limited to this. In an embodiment of the disclosure, it is preferable that a plurality of circuit type names and a plurality of circuit diagrams stored in advance in the storage unit 191 be displayed using the output device 905, and the customer (designer) select a circuit type name and a circuit diagram to be used from the displayed circuit type names and circuit diagrams.

In step S2, on the basis of the circuit information acquired by the input device, the circuit component information acquiring unit 101 acquires component information (circuit component information) required for the foregoing circuit configuration, specifically, information about circuit components to be included in the circuit from a circuit database 210. As a specific example, the circuit component information is a component type name such as a diode, a transistor, a capacitor, or a coil. In an embodiment of the disclosure, the circuit component information may contain a netlist covering connection between circuit components. For example, information in the netlist is used in making design of wiring in the component embedded substrate or design of wiring on a mounting board between the component embedded substrate and a different component. In an embodiment of the disclosure, the circuit information input by the designer (customer) preferably contains information about an operating condition of the circuit (hereinafter also called “operating information”). More specifically, the operating information contains an operating condition of the circuit such as a breakdown voltage, a current value, or an operating frequency, for example. The operating information is used in acquisition of component information described later. In an embodiment of the disclosure, in step S2 in FIG. 2, information such as a value of a thermal resistance required for the component embedded substrate or an insulation structure (insulation: heat dissipation on upper surface, insulation: heat dissipation on lower surface, non-insulation: heat dissipation on upper surface, non-insulation: heat dissipation on lower surface, for example) may be input in addition to the foregoing circuit information.

In step S3, the incorporated component selecting unit 102 selects a component to be incorporated in the component embedded substrate from the circuit components (constituting components of the circuit) acquired by the circuit component information acquiring unit 101. In an embodiment of the disclosure, an active component is selected as an incorporated component from the constituting components of the circuit, for example. As a more specific example, if the circuit configuration is a step-down chopper circuit and if the circuit diagram is the circuit diagram illustrated in FIG. 3, switching elements T1 and T2 as active components are selected as components to be incorporated in the component embedded substrate. Such selection may be made on the basis of the foregoing criterion (whether a component is an active component) or on the basis of another criterion for selection. Specifically, in an embodiment of the disclosure, not only the active component but also a passive component may be selected as a component to be incorporated in the component embedded substrate. The foregoing criterion for selection is preferably stored in advance into the storage unit 191. In an embodiment of the disclosure, the incorporated component selecting unit 102 may acquire incorporated component information selected and input by an external designer (customer) from the input device 904 or from an external terminal belonging to the designer (customer). In the present description, a designer to operate the processor is called an “internal designer,” a designer to operate an external terminal connected to the design support apparatus through a network or the like is called an “external designer,” and the internal designer and the external designer are also collectively called a designer.

In step S4, the component information acquiring unit 103 acquires component identifying information from a component database stored in the storage unit 191 that is information corresponding to the component selected by the incorporated component selecting unit. In this step, the component information acquiring unit 103 acquires component identifying information conforming to the operating information contained in the circuit information described above input by the designer, and selects a component corresponding to the acquired component identifying information as an incorporated component. If the component identifying information conforming to the foregoing operating information includes a plurality of component identifying information pieces, these pieces of component identifying information may be output together with other information about components (cost, name of manufacturer, specification) through the output device 905, and the designer may select a component to be used. The component identifying information is information identifying the incorporated component. As a more specific example, the component identifying information is a component identifier of each component (the name of the component, for example).

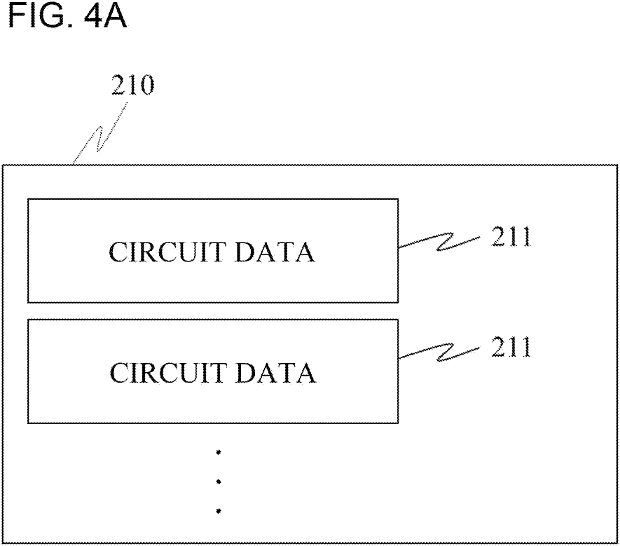

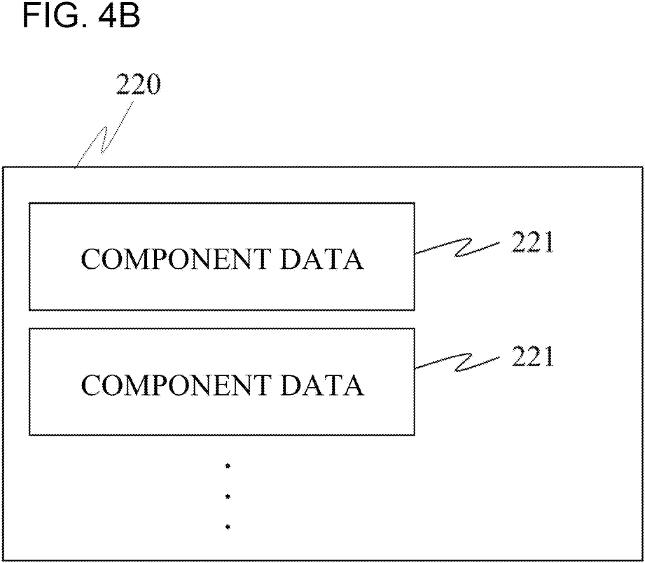

The circuit database and the component database will be described using FIGS. 4A and 4B. The circuit database 210 illustrated in FIG. 4A is a group of pieces of circuit data 211 and is stored in advance into the storage unit 191. The circuit data 211 contains information about a circuit such as a circuit type name, a circuit diagram, the type and the number of constituting components, etc. A component database 220 illustrated in FIG. 4B is a group of pieces of component data 221 and is stored in advance into the storage unit 191. The component data 221 contains information about a component provided in a general component database such as the component identifier, an outer shape of the component, electrical characteristics of the component, etc. The component identifier indicates information usable for identifying each component such as the name of the component, for example. The outer shape of the component indicates the shape and size (dimension) of the component. In an embodiment of the disclosure, the outer shape of the component preferably contains information about the shape and size of the component as a bare chip. Containing such information makes it possible to make a design more smoothly in incorporating into the component embedded substrate. If the component is an IGBT, for example, the electrical characteristics of the component are information provided in a device datasheet or information about various types of performance graphs such as a collector-emitter voltage, gate breakdown voltage, a collector current, a junction temperature, etc. In an embodiment of the disclosure, if the component is an active component such as a diode or a transistor, the component data 221 preferably contains characteristic information about a semiconductor component. If the semiconductor component is a transistor, examples of the semiconductor component characteristic information include a saturation voltage of the transistor such as Vce (collector-to-emitter saturation voltage), Eon (turn-on loss), Eoff (turn-off loss), Tr (rise time), and Tf (fall time). If the semiconductor component is a diode, examples of the semiconductor component characteristic information include Vf (forward voltage) and Err (reverse recovery loss). Such semiconductor component characteristic information is used preferably in calculation of loss described later.

In step S5, on the basis of the component identifying information acquired by the component information acquiring unit 103, the pad information acquiring unit 104 derives a component type name and the number of components, thereby acquiring pad information. The pad information contains at least information about the type and the number of electrode pads to be arranged on a surface of the component embedded substrate. The pad information is generally determined uniquely by the type name and the number of components to be mounted on the component embedded substrate. Preferably, a combination of the type name and the number of the components with the type and the number of the pads is stored in advance into the storage unit 191. Table 1 illustrates an example of the combination of the type name and the number of the components with the pad information.

TABLE 1

| Component type name | Number | Pad information |
|---|---|---|
| IGBT | 2 | Power source pad (input pad) × 1, Power source pad (output pad) × 1, Ground pad × 1, Signal pad × 4 |

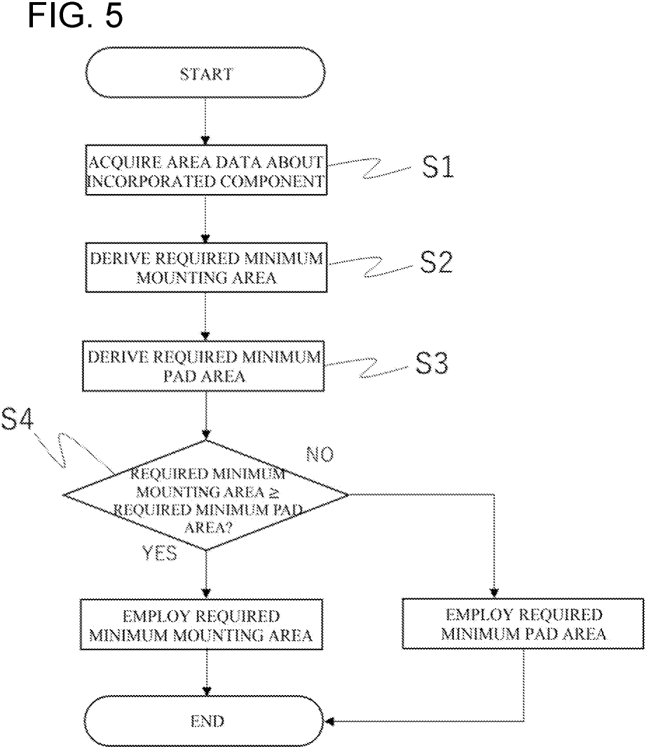

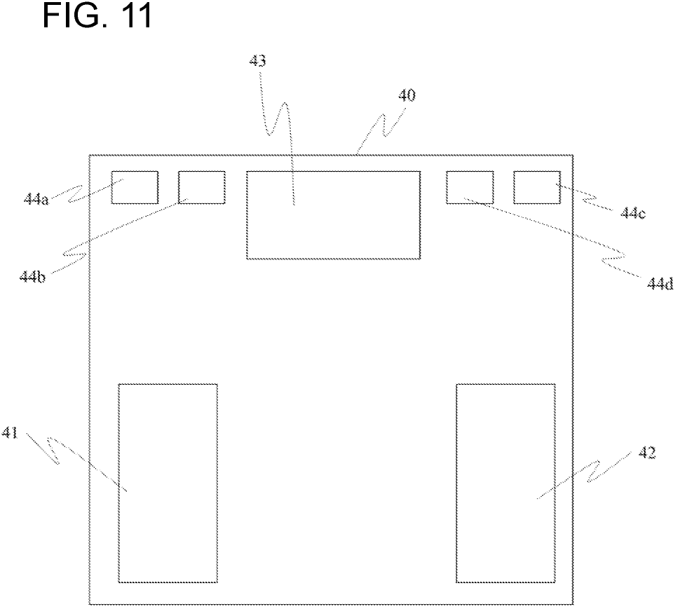

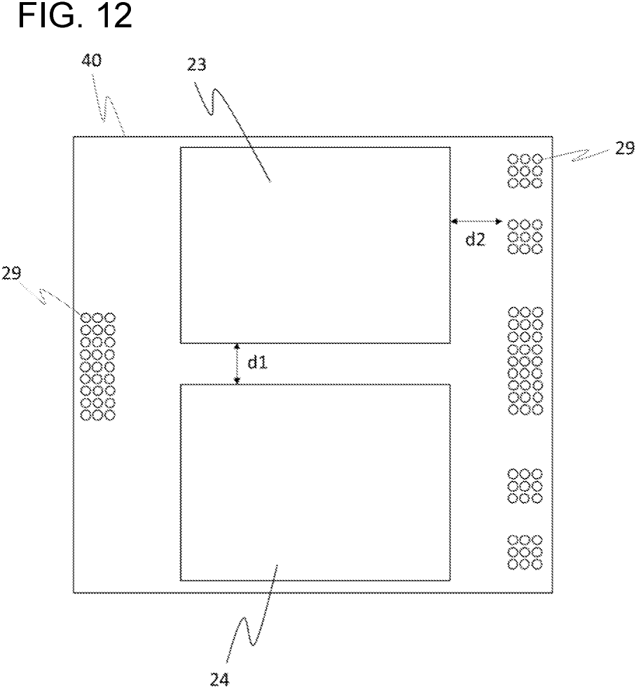

In step S6, the area information acquiring unit 105 derives a required minimum area (area information) on the surface of the component embedded substrate on the basis of a required minimum mounting area and a required minimum pad area. FIG. 11 illustrates an example of layout of electrode pads on the surface of the component embedded substrate. A component embedded substrate 40 in FIG. 11 includes power source pads 41 and 42, a ground pad 43, and signal pads 44a to 44d formed on a surface of the component embedded substrate 40. The required minimum area mentioned herein means a required minimum area of a rectangular region surrounded by an outer periphery of the component embedded substrate 40 in FIG. 11. A processing procedure of acquiring the area information by the area information acquiring unit 105 will be described in more detail using FIG. 5. In step S1 in FIG. 5, information about the size of each electronic component (area data) to be incorporated on the component embedded substrate is acquired from the component database illustrated in FIG. 4B. Next, in step S2 in FIG. 5, on the basis of the acquired area data about each electronic component, a required minimum mounting area of the component embedded substrate is calculated. The required minimum mounting area is calculated by multiplying a total of the acquired area data about each electronic component described above by a mounting factor. The mounting factor mentioned herein is a factor for setting a mounting area by giving consideration to a through hole forming region, a spacing distance between each components, etc. relating to preparation of the component embedded substrate. The mounting factor is stored in advance into the storage unit 191 as a table indicating correspondence between the number of embedded components and the mounting factor, for example. The idea of the mounting factor used in deriving the required minimum mounting area will be described in more detail using FIG. 12. FIG. 12 is a sectional view taken along an arbitrary section vertical to a stacking direction in the component embedded substrate. The component embedded substrate 40 illustrated in FIG. 12 includes at least a first semiconductor component (electronic component) 23, a second semiconductor component (electronic component) 24, and a through hole 29. The mounting factor used in determining the required minimum mounting area is preferably set in advance by giving consideration to a spacing distance d1 between the first semiconductor component 23 and the second semiconductor component 24, a spacing distance d2 from each or either of the first semiconductor component 23 and the second semiconductor component 24 to the through hole 29, and a forming region for the through hole 29, for example.

In the present embodiment, geometry information about the component embedded substrate is preferably acquired in step S4 in FIG. 2. The geometry information about the component embedded substrate means information such as the number of layers in the component embedded substrate, a material of a conductive layer, a material of an insulating layer, and specifications of a heat dissipation plate, etc. Preferably, the geometry information about the component embedded substrate is prepared in advance as a database in association with the type and the number of components to be mounted, etc. The geometry information is used in extraction of temperature increase of an electrode pad described later.

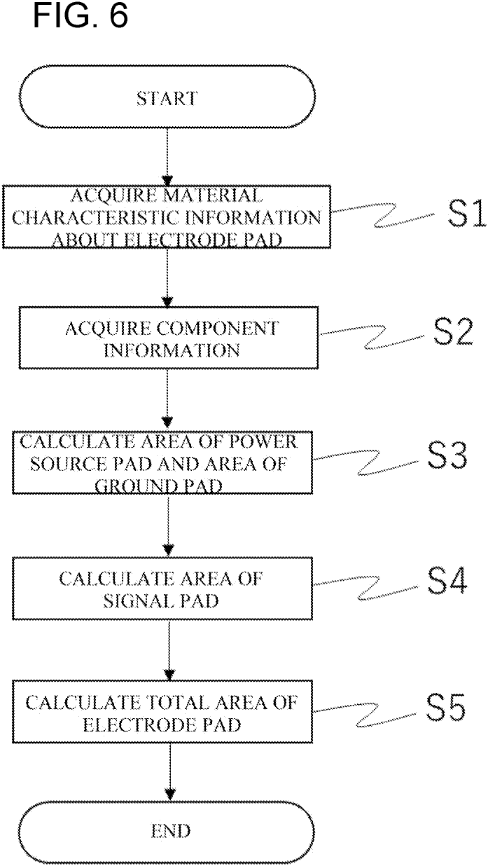

Next, in step S3 in FIG. 5, a required minimum pad area is derived. The required minimum pad area is derived by adding respective required minimum areas for all pads (power source pad, ground pad, and signal pad). The required minimum pad area is derived using publicly-known calculation means on the basis of the pad information (including the type and the number of pads) acquired by the pad information acquiring unit 104 in FIG. 1, the component information (including a maximum current value of a component), etc. acquired by the component information acquiring unit 103 in FIG. 1. While an example of a procedure of deriving the required minimum pad area will be described using FIG. 6, the procedure in FIG. 6 is given as an example and the disclosure is not limited to this.

In step S1 in FIG. 6, material characteristic information about an electrode pad is first acquired from an electrode pad database stored in the storage unit 191. The material characteristic information about the electrode pad contains at least a sheet resistance Rₛₑ and a sheet thermal resistance Rₛₜ of the electrode pad. A value of the sheet thermal resistance Rₛₜ is derived on the basis of a list of sheet thermal resistances of electrode pads defined in advance for each mounting configuration and information about a mounting configuration input by the designer (customer), for example. Table 2 illustrates an example of the information about the mounting configuration input by the designer (customer). The electrode pad database is preferably stored in advance into the storage unit 191.

TABLE 2

| | |
|---|---|
| Item | Detail |
| Layer structure | First layer, second layer, ... |
| Copper foil thickness | First layer: 0.035 mm, ... |
| Material | FR4 |

Next, in step S2 in FIG. 6, component information is acquired from the component database in the storage unit 191. The acquired component information contains at least a value of a maximum current value I_{F} of a corresponding electronic component in the circuit. In step S3 in FIG. 6, the area of a power source pad (including Vin pad and Vout pad) and that of a ground pad are calculated. Step S3 will be described in detail below.

In step S3 in FIG. 6, a permissible value for temperature increase in the electrode pad is extracted first. A value input by the designer using the input device 904 may be used as the permissible value for temperature increase in the electrode pad. The permissible value is determined in advance according to the configuration of the component embedded substrate and is preferably extracted by referring to a value stored in advance into the storage unit 191 in association with the configuration of the component embedded substrate. Next, on the basis of the material characteristic information (sheet resistance, sheet thermal resistance) about the electrode pad and the component information (flowing maximum current) acquired in step S1 and step S2 in FIG. 6 respectively and the acquired permissible value for temperature increase in the electrode pad described above, a required minimum area is calculated for the electrode pad (including power source pad and ground pad) using a formula (1) and a formula (2) given below. In the present embodiment, it is assumed that the area of the power source pad (each of Vin pad and Vout pad) and that of the ground pad are equal to each other. Accordingly, the required minimum area of the power source pad and the ground pad is obtained by multiplying an area determined by using the formula (1) and the formula (2) given below by the number of the pads.

$$Δ \text{T} \text{=} {R}_{s e} \times S \times {I}_{f}^{2} \times {R}_{s t} \times S \qquad \text{[Formula 1]}$$

[In this formula, ΔT indicates a permissible value for temperature increase in the electrode pad, Rₛₑ indicates a sheet resistance, S indicates the area of the electrode pad, I_{f} indicates a flowing maximum current, and Rₛₜ indicates a sheet thermal resistance.]

$$\text{S} \text{=} \sqrt{\frac{Δ T}{{R}_{s e} \times {I}_{f}^{2} \times {R}_{s t}}} \qquad \text{[Formula 2]}$$

[In this formula, ΔT indicates a permissible value for temperature increase in the electrode pad, Rₛₑ indicates a sheet resistance in the electrode pad, S indicates the area of the electrode pad, I_{f} indicates a flowing maximum current, and Rₛₜ indicates a sheet thermal resistance of the electrode pad.]

Next, in step S4 in FIG. 6, the area of a signal pad is acquired. In an embodiment of the disclosure, on the assumption that the area of the signal pad is determined according to a manufacturing condition, an area of one signal pad is preferably stored in advance into the storage unit 191. Accordingly, in step S4 in FIG. 6, the area of the signal pad is calculated by multiplying an area of one signal pad by the number of signal pads.

Finally, in step S5 in FIG. 6, the area of the power source pad and that of the ground pad calculated in step S3 in FIG. 6 and the area of the signal pad calculated in step S4 in FIG. 6 are added to each other to derive a required minimum pad area. The required minimum pad area is derived by further making multiplication by a factor defined by giving consideration to a spacing distance between the electrode pads. This factor is stored in advance into the storage unit 191.

The processing procedure in FIG. 5 will be described again. As described above using FIG. 6, after calculation of the required minimum pad area, the required minimum mounting area and the required minimum pad area are compared to each other in step S4 in FIG. 5 and an area determined to be larger is derived as a required minimum area of the component embedded substrate. The derived required minimum area is output using the output unit 193. In an embodiment of the disclosure, information about the acquired required minimum area is preferably displayed from the output unit 193 on a display of the external terminal belonging to the customer through a network, for example. In an embodiment of the disclosure, the information about the required minimum area is preferably displayed together with the component information. Such a preferable configuration allows the designer (customer) to go forward with making of the design efficiently while giving consideration to the component information. While not illustrated in the drawings, if a value of the acquired required minimum area does not satisfy requirement by the designer, design may be made again by returning to the selection of an incorporated component in step S3 or to the acquisition of component information in step S4 in FIG. 2, for example.

The details of the steps and the order of implementation of the steps in the present embodiment are given merely as examples and the disclosure is not limited to the examples given above. This also applies to embodiments described below. In particular in the present embodiment, step S5 in FIG. 2 and steps S3 and S4 in FIG. 5 are omissible, and the required minimum mounting area derived in step S2 in FIG. 5 may be employed as it is as a required minimum area of the component embedded substrate.

As described above, according to the present embodiment, it is possible to make optimum dimensional design by giving consideration to an element peculiar to a component embedded substrate.

### (Second Embodiment)

In a second embodiment, the configuration of a design support apparatus 100 is the same as that of the first embodiment (FIG. 1).

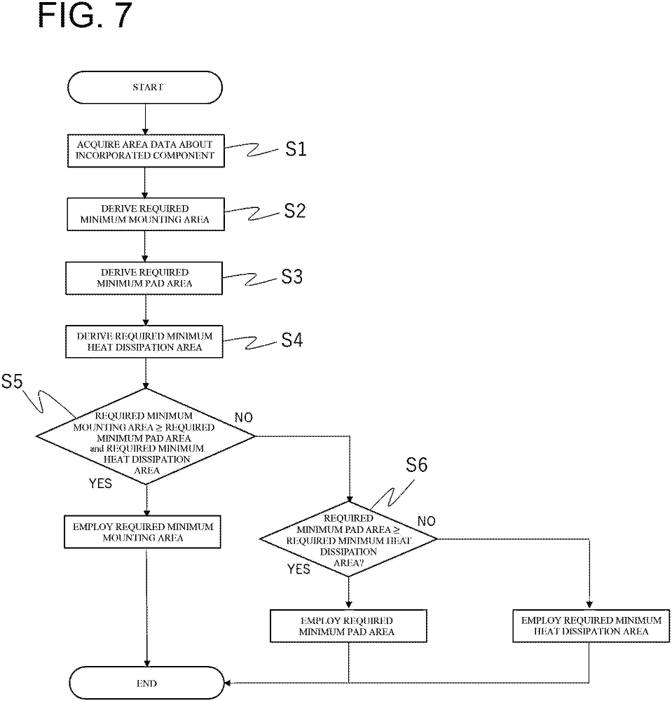

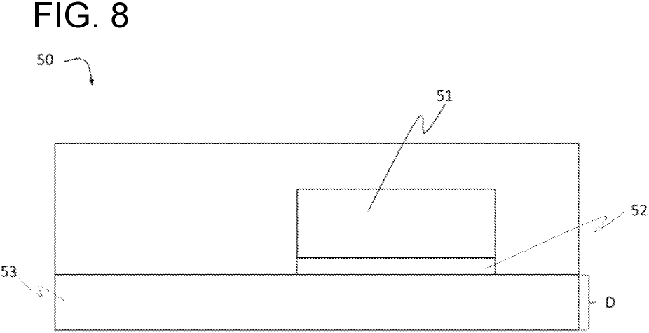

The operation of the design support apparatus (design support method) according to the second embodiment of the disclosure will be described below using FIG. 7. A processing flow of the design support method according to the present embodiment differs from that of the first embodiment in that a required minimum heat dissipation area is derived in step S4 in FIG. 7, and that a largest area of a required minimum mounting area, a required minimum pad area, and the required minimum heat dissipation area derived in steps S2 to S4 respectively is employed as a required minimum area in steps S5 and S6 in FIG. 7. In the present embodiment, the required minimum heat dissipation area is further used in deriving the required minimum area of a component embedded substrate as described above. This makes it possible to make design by giving consideration to an aspect of heat dissipation at an early stage, allowing design of the component embedded substrate to be made more efficiently. While a procedure of deriving the required minimum heat dissipation area will be described below, the disclosure is not limited to this but another method employing a publicly-known heat calculation method is applicable. The required minimum heat dissipation area may be derived using a formula (3) given below, for example. The formula (3) and a formula (4) given below are examples of a process of deriving a required heat dissipation area and the disclosure is not limited to these. A junction-to-case thermal resistance is calculated using a simplified model illustrated in FIG. 8 and on the basis of the following formula (3). A thermal resistance R_{d} of a die bonding material 52 is a value known from a material datasheet. A thermal resistance Rₕ of a heat dissipation plate 53 may be obtained from the thermal resistivity of the heat dissipation plate, the thickness of the heat dissipation plate, and the area of the heat dissipation plate. On the assumption that the thickness of the heat dissipation plate to be used is determined in advance according to the specifications of the component embedded substrate, this thickness takes a numerical value stored in advance into the storage unit 191. It is assumed that the area of the heat dissipation plate is the same as the required minimum mounting area obtained in step S2 in FIG. 5.

$${R}_{j c} = {R}_{d} + {R}_{h} \qquad \text{[Formula 3]}$$

[In this formula, R_{jc} indicates a junction-to-case thermal resistance, R_{d} indicates a thermal resistance of a die bonding material, and Rₕ indicates a thermal resistance of a heat dissipation plate.]

$${T}_{j m a x} - {T}_{c} = Q {R}_{j c} \qquad \text{[Formula 4]}$$

[In this formula, Tⱼₘₐₓ indicates a maximum junction temperature, T_{c} indicates the temperature of an electrode pad, Q indicates loss, and R_{jc} indicates a junction-to-case thermal resistance.]

The loss Q is a total value of loss caused by an electronic component (semiconductor component) incorporated in the component embedded substrate. In an embodiment of the disclosure, if the electronic component (semiconductor component) includes a transistor and a diode, for example, loss by the transistor and loss by the diode are calculated using the semiconductor component characteristic information described above and using a publicly-known loss calculation method, and a total of the losses is derived as the loss Q.

As described above, according to the present embodiment, in making design including derivation of a required minimum area of a component embedded substrate, it is possible to make the design by giving consideration to a thermal aspect as well as to a physical aspect.

### (Third Embodiment)

A third embodiment of the disclosure will be described below by referring to the drawings. Description to overlap the one given in the first embodiment will be omitted or simplified.

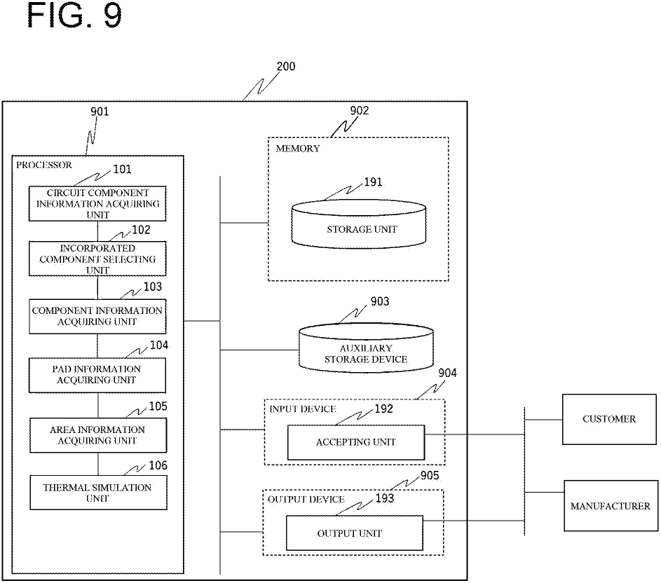

FIG. 9 is a block diagram illustrating the configuration of a design support apparatus according to the third embodiment. A unit corresponding to that of the first embodiment is given the same sign. A unit functioning in the same way as in the first embodiment will not be described. The design support apparatus illustrated in FIG. 9 differs from the design support apparatus in FIG. 1 in that a thermal simulation unit is further provided.

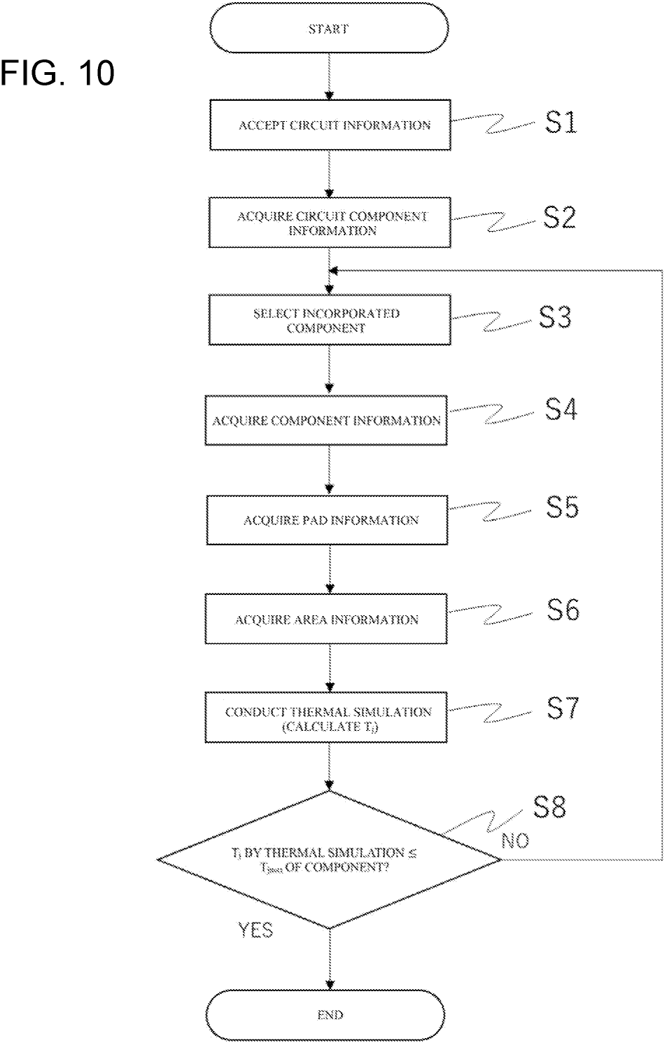

The operation of a design support apparatus 200 (design support method) according to the third embodiment of the disclosure will be described below using FIG. 10. A processing flow of the design support method according to the present embodiment is the same as that of the first embodiment except steps S7 and S8 in FIG. 10. In step S7 in FIG. 10, on the basis of design information about a component embedded substrate containing information about a required minimum area of the component embedded substrate acquired in step S6, thermal simulation is conducted using a publicly-known thermal analysis method to calculate Tⱼ. The publicly-known thermal analysis method may be a publicly-known method such as a method described Japanese Pat. No. 6745614 or may be a method using commercially-available thermal analysis simulation software. Design information additionally required for conducting the thermal simulation (the number of substrate layers, material physical properties, etc. in the component embedded substrate, for example) may be input from a designer (customer) using the input device 904 or an external terminal belonging to the customer. Alternatively, such design information to be used may information containing information about a combination including the number of components and the number of terminals to be incorporated in the component embedded substrate and the number of substrate layers and stored in advance into the storage unit 191 in the form of a table, for example. In the present embodiment, Tⱼ is calculated through the thermal simulation and a comparison between the values of Tⱼ and Tⱼₘₐₓ is used as a criterion for determination. However, the disclosure is not limited to these. A different thermal characteristic value may be calculated through thermal simulation, or another criterion for determination may be employed.

In step S8 in FIG. 10, a value of Tⱼ calculated in step S7 and a value of Tⱼₘₐₓ of a corresponding component are compared to each other. If Tⱼ ≤ Tⱼₘₐₓ is satisfied, it is determined that the design is completed. If Tⱼ ≤ Tⱼₘₐₓ is not satisfied, the processing is performed again from the selection of an incorporated component in step S3. A value acquired from the component database may be used as it is as a value of Tⱼₘₐₓ. Alternatively, a value obtained by multiplication by a safety factor such as 0.9, for example, may be used in step S8.

As described above, according to the present embodiment, information about a required minimum area of a component embedded substrate calculated by the design support apparatus is further used for thermal simulation, making it possible to improve design to a greater extent.

According to the embodiments, the function of the design support apparatus 100 or 200 may be realized using hardware. Specifically, the design support apparatus 100 or 200 may include one or two or more processing circuits and the processing circuit may realize the functions of the “units.” The design support apparatus 100 or 200 may be realized using a combination of software and hardware. Specifically, some of the “units” may be realized using software, and the other “units” may be realized using hardware.

Some or all of a plurality of the embodiments described above according to the disclosure may certainly be combined, or some of the constituting elements may certainly be applied to the other embodiment. Such a configuration also belongs to an embodiment of the disclosure.

### Industrial Applicability

The design support apparatus, the design support method, and the design support program of the disclosure are available in any field including semiconductors (such as compound semiconductor electronic devices, for example), electronic components, electric equipment components, optical electrophotographic related apparatuses, and industrial members, and especially useful for electronic component embedded substrates with embedded power devices.

The embodiments of the present invention are exemplified in all respects, and the scope of the present invention includes all modifications within the meaning and scope equivalent to the scope of claims.

[Reference Signs List]

| | |
|---|---|
| 23 | First semiconductor component (electronic component) |
| 24 | Second semiconductor component (electronic component) |
| 29 | Through hole |
| 40 | Component embedded substrate |
| 41 | Power source pad (input pad) |
| 42 | Power source pad (output pad) |
| 43 | Ground pad |
| 44 a | Signal pad |
| 44 b | Signal pad |
| 44 c | Signal pad |
| 44 d | Signal pad |
| 50 | Component embedded substrate |
| 51 | Chip |
| 52 | Die bonding material |
| 53 | Heat dissipation plate |
| 101 | Circuit component information acquiring unit |
| 102 | Incorporated component selecting unit |
| 103 | Component information acquiring unit |
| 104 | Pad information acquiring unit |
| 105 | Area information acquiring unit |
| 191 | Storage unit |
| 192 | Accepting unit |
| 193 | Output unit |
| 200 | Design support apparatus |
| 210 | Circuit database |
| 211 | Circuit data |
| 220 | Component database |
| 221 | Component data |
| 901 | Processor |
| 902 | Memory |
| 903 | Auxiliary storage device |
| 904 | Input device |
| 905 | Output device |

What is claimed is:

1. A design support apparatus of supporting design of a component embedded substrate including one or more embedded electronic components that configure at least a part of a circuit, comprising:
a component information acquiring unit that acquires component information about the electronic components to be incorporated in the component embedded substrate; and
a required minimum area calculating unit that calculates a required minimum area of a surface of the component embedded substrate on the basis of at least information about a size of each electronic component contained in the component information.

2. The design support apparatus according to claim 1, further comprising:
a circuit component information acquiring unit that acquires information about circuit components to be included in the circuit from a circuit database containing information about a configuration of the circuit; and
an incorporated component selecting unit that selects a component to be incorporated in the component embedded substrate from the circuit components,
the component information acquiring unit acquiring information about one or more electronic components selected by the incorporated component selecting unit.

3. The design support apparatus according to claim 1, wherein
the required minimum area of the component embedded substrate is calculated by using a required minimum mounting area that is derived on the basis of a component area obtained as a total of each area of the electronic components to be incorporated in the component embedded substrate.

4. The design support apparatus according to claim 1, wherein
the required minimum area is calculated by using a required minimum pad area that is derived on the basis of each area of one or more electrode pads to be mounted on the surface of the component embedded substrate.

5. The design support apparatus according to claim 4, wherein
the required minimum pad area is derived on the basis of geometry information containing at least information about a layer structure, a copper foil thickness, and a substrate material of a mounting board on which the component embedded substrate is to be mounted.

6. The design support apparatus according to claim 1, wherein
at least one of the electronic components is a power device.

7. The design support apparatus according to claim 1, wherein
the required minimum area of the component embedded substrate is calculated by further using a required heat dissipation area of the component embedded substrate.

8. The design support apparatus according to claim 1, further comprising:
a thermal simulation unit that conducts a thermal simulation on the component embedded substrate by using information about the required minimum area.

9. A computer-readable non-transitory recording medium storing a program that causes a computer to execute a procedure, the procedure that supports design of a component embedded substrate including one or more embedded electric components configuring at least a part of a circuit, the procedure comprising: acquiring component information about the electronic components to be incorporated in the component embedded substrate; and
calculating a required minimum area of a surface of the component embedded substrate on the basis of at least information about a size of each electronic component contained in the component information.

10. A design support method of supporting design of a component embedded substrate including one or more embedded electronic components that configure at least a part of a circuit, comprising at least:
acquiring component information about the electronic components to be incorporated in the component embedded substrate; and
calculating a required minimum area of a surface of the component embedded substrate on the basis of at least information about a size of each electronic component contained in the component information.
